(19) United States
(12) Patent Application Publication
(10) Pub. No.: US 2023/0350713 A1
(43) Pub. Date: Nov. 2, 2023

(54) PARALLEL PROCESSING ARCHITECTURE WITH COUNTDOWN TAGGING

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 18/220,331

(22) Filed: Jul. 11, 2023

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/402,490, filed on Aug. 31, 2022.
(60) Provisional application No. 63/400,087, filed on Aug. 23, 2022.
(60) Provisional application No. 63/393,989, filed on Aug. 1, 2022.
(60) Provisional application No. 63/388,268, filed on Jul. 12, 2022.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/48; G06F 11/30; G06F 15/80

(52) U.S. Cl. CPC G06F 9/485; G06F 11/3055; G06F 15/80

(57) ABSTRACT

Techniques for parallel processing based on a parallel processing architecture with countdown tagging are disclosed. A two-dimensional array of compute elements is accessed. Each compute element within the array is known to a compiler and is coupled to its neighboring compute elements within the array of compute elements. A load operation is tagged with a countdown tag. Tagging is performed by the compiler, and the load operation is targeted to a memory system associated with the array of compute elements. The countdown tag comprises a time value. The time value is decremented as the load operation is being performed. The time value that is decremented is based on an architectural cycle. Countdown tag status is monitored by a control unit. The monitoring occurs as the load operation is performed. A load status is generated by the control unit, based on the monitoring. The load status allows compute element operation.

### RELATED APPLICATIONS

This application claims the benefit of U.S. provisional patent applications “Parallel Processing Architecture With Countdown Tagging” Ser. No. 63/388,268, filed Jul. 12, 2022, “Parallel Processing Architecture With Dual Load Buffers” Ser. No. 63/393,989, filed Aug. 1, 2022, “Parallel Processing Architecture With Bin Packing” Ser. No. 63/400,087, filed Aug. 23, 2022, “Parallel Processing Architecture With Memory Block Transfers” Ser. No. 63/402,490, filed Aug. 31, 2022, “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, and “Parallel Processing Hazard Mitigation Avoidance” Ser. No. 63/460,909, filed Apr. 21, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to a parallel processing architecture with countdown tagging.

### BACKGROUND

The processing of a wide variety of data types is mission critical to organizations including commercial, educational, governmental, medical, research, and retail ones. The sets of data, or datasets, are immense, diverse, and most often unstructured. The data processing requires the organizations to commit considerable financial, physical, and human resources to accomplish their missions, as their success directly relies on processing the data to its financial and competitive advantage. The organization flourishes when the data processing successfully accomplishes the organizational objectives. If the data processing is unsuccessful, then the organization founders. The data that is obtained for processing is collected based on many data collection techniques. These collection techniques are used to collect data from a wide range of individuals. The individuals include citizens, customers, patients, purchasers, students, test subjects, and volunteers. While some individuals are willing data collection participants, others are unwitting subjects or even victims of the data collection. Common legitimate data collection strategies often include “opt-in” techniques, where an individual enrolls, registers, creates an account, or otherwise agrees to participate in the data collection. Other techniques are legislative, such as a government requirement that citizens obtain a registration number and that they use that number while interacting with government agencies, law enforcement, emergency services, and others. Further data collection techniques are subtle or covert, such as tracking purchase histories, website visits, button clicks, and menu choices. The collected datasets are highly valuable to the organizations, irrespective of the data collection techniques employed. The rapid processing of this large amount of data is critical.

### SUMMARY

The immense quantity and mix of processing jobs performed by organizations is mission critical to the success of the organizations. The job processing tasks typically include running payroll, analyzing research data, processing academic grades, or training a neural network for machine learning. These processing jobs are highly complex. The jobs are composed of many tasks. Common tasks include loading and storing various datasets, accessing processing components and systems, executing the data processing jobs, and so on. The tasks themselves are most often based on subtasks which themselves can be complex. The subtasks can be used to handle specific jobs such as loading or reading data from storage, performing computations and other manipulations on the data, storing or writing the data back to storage, handling inter-subtask communication such as data transfer and subtask control, and so on. The datasets that are accessed are often colossal and easily saturate processing architectures that are ill suited to the processing tasks or inflexible in their designs. Task processing efficiency and throughput can be greatly increased by using two-dimensional (2D) arrays of elements for the processing of the tasks and subtasks. The 2D arrays include compute elements, multiplier elements, registers, caches, queues, controllers, decompressors, arithmetic logic units (ALUs), storage elements, and other components which can communicate among themselves. To further improve the processing efficiency and throughput, data load operations can be tagged with a countdown tag. The tag is assigned to the load operation by a compiler, and the load operation is targeted to a memory system that includes levels of cache, an access buffer, a crossbar switch, or a memory logic block. The tag is examined in one or more blocks of the memory system. Further, any of the memory system blocks can signal a control unit in the event that the countdown tag has expired. The status of the countdown tag, whether valid or expired, can allow or halt compute element operation. If the countdown tag is valid, then compute element operation is allowed. If the countdown tag has expired, then compute element operation is halted. The load status further enables static scheduling integrity of a schedule associated with the compute elements. The static scheduling integrity overcomes indeterminate memory load latency.

Parallel processing is based on a parallel processing architecture with countdown tagging. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit based on the monitoring. The load status allows compute element operation, based on a valid countdown tag. The load status halts compute element operation, based on an expired countdown tag.

A method for parallel processing is disclosed comprising: accessing a two-dimensional (2D) array of compute elements, wherein each compute element within the array of compute elements is known to a compiler and is coupled to its neighboring compute elements within the array of compute elements; tagging a load operation with a countdown tag, wherein the tagging is performed by the compiler, and wherein the load operation is targeted to a memory system associated with the 2D array of compute elements; monitoring countdown tag status by a control unit, wherein the monitoring occurs as the load operation is performed; and generating a load status, by the control unit, based on the monitoring. In embodiments, the countdown tag comprises a time value. In embodiments, the time value is decremented as the load operation is being performed. In embodiments, the time value that is decremented is based on an architectural cycle, which is established by the compiler. In embodiments, the architectural cycle comprises one or more physical cycles, and the physical cycles represent actual wall clock time.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture with countdown tagging.

FIG. 2 is a flow diagram for load status handling.

FIG. 3 is a high-level system block diagram for load tagging.

FIG. 4 illustrates a system block diagram for a highly parallel architecture with a shallow pipeline.

FIG. 5 shows compute element array detail.

FIG. 6 illustrates a system block diagram for compiler interactions.

FIG. 7 is a system diagram for a parallel processing architecture with countdown tagging.

### DETAILED DESCRIPTION

Techniques for a parallel processing architecture with countdown tagging are disclosed. The countdown tagging enables a controller to track load requests submitted to a memory system. The load requests are initiated by tasks, subtasks, and so on that are generated by a compiler. As the load requests are issued, the load requests are tagged with a countdown tag. The tagging of the load requests is performed by the compiler. The countdown tag indicates an amount of time, a number of cycles, and so on that can elapse during which the data associated with the load request is required to arrive at the compute element that initiated the load request. A countdown tag status is monitored by a control unit. The monitoring can include tracking the countdown tag as a load request is executed. The monitoring can include aggressive monitoring, where the countdown tag is examined during each cycle as the load operation is occurring; passive monitoring, where the countdown tag status is presumed to be valid unless an error or exception occurs; and the like. The control unit can generate a load status. The countdown status can include “valid”, indicating that the load request is still within a permissible arrival window, and “expired”, indicating that the load data is late.

In order for tasks, subtasks, and so on to execute properly (particularly in a statically scheduled architecture), data associated with a load request must arrive at one or more destination compute elements within a time value window defined by the compiler. The countdown tag flows through the memory system—including an interconnect between the array and the memory—in conjunction with the load data and the load address. As the countdown tag flows through the memory system, the countdown tag is examined in one or more blocks of the memory system. The memory system blocks that examine the countdown tag can include a load buffer, a level 1 (L1) cache, a level 2 (L2) cache, a level 3 (L3) cache, an access buffer, a crossbar switch, or a memory logic block. The examining can include reading the countdown tag, adjusting the tag (e.g., decrementing the tag), etc. The examining the tag can result in an update or a signal being sent to the control unit. The control unit is signaled of a countdown tag expiration by at least one of the one or more blocks of the memory system. The countdown tag expiration is indicative of late load data status. Late load data can cause an interruption on array operation because data required for execution of one or more operations is not available at the array at the scheduled time (i.e., by the scheduled cycle). The control unit can generate load status, update load status, and so on based on the signaling to the control unit from one or more memory system blocks. The load status allows compute element operation, based on a valid countdown tag, and the load status may result in the control unit halting compute element operation, based on an expired countdown tag.

The data manipulations are performed on a two-dimensional (2D) array of compute elements. The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage which can include local memory elements, register files, cache storage, etc. The cache, which can include a hierarchical cache such as a level-1 (L1), a level-2 (L2), and a level-3 (L3) cache working together, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where one or more control words are generated by the compiler. The control words are provided to the array on a cycle-by-cycle basis. The control words can include wide microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which decompresses the control words. The decompressed control words enable processing by the compute elements. The task processing is enabled by executing the one or more control words. In order to accelerate the execution of tasks, to reduce or eliminate stalling for the array of compute elements, and so on, copies of data can be broadcast to a plurality of physical register files comprising 2R1 W memory elements. The register files can be distributed across the 2D array of compute elements.

A parallel processing architecture with countdown tagging enables parallel processing. The task processing can include data manipulation. A two-dimensional (2D) array of compute elements is accessed, wherein each compute element within the array of compute elements is known to a compiler and is coupled to its neighboring compute elements within the array of compute elements. The compute elements can include compute elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Thus, the compiler can control data flow between and among the compute elements and can also control data commitment to memory outside of the array.

A load operation is tagged with a countdown tag, wherein the tagging is performed by the compiler, and wherein the load operation is targeted to a memory system associated with the 2D array of compute elements. The tag can be based on a time value and the time value can be decremented as the load is being performed. The tag can include an amount of time such as a “time to live”, a number of operation cycles, a number of architectural cycles, and so on. An architectural cycle is established by the compiler and can include one or more physical cycles. A physical cycle can represent actual wall clock time. The countdown tag status is monitored by a control unit, wherein the monitoring occurs as the load operation is performed. The monitoring can include determining whether the countdown tag is valid or expired. Further, the countdown tag is examined in one or more blocks of the memory system. The control unit is signaled of a countdown tag expiration by at least one of the one or more blocks of the memory system. A load status is generated by the control unit based on the monitoring. The load status allows compute element operation, based on a valid countdown tag. Based on the load status, the control unit may halt compute element operation, due to an expired countdown tag.

The array of compute elements is controlled on a cycle-by-cycle basis, wherein the controlling is enabled by a stream of wide control words generated by the compiler. A cycle can include a clock cycle, an architectural cycle, a system cycle, etc. The stream of wide control words generated by the compiler provides direct, fine-grained control of the 2D array of compute elements. The fine-grained control can include control of individual compute elements, memory elements, control elements, etc.

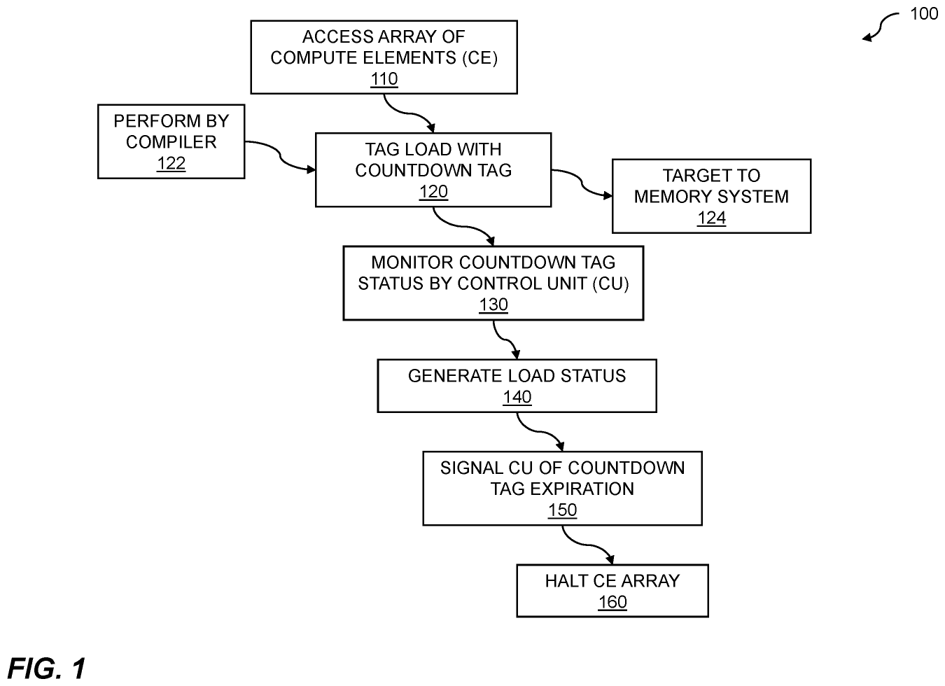

FIG. 1 is a flow diagram for a parallel processing architecture with countdown tagging. Groupings of compute elements (CEs), such as CEs assembled within a 2D array of CEs, can be configured to execute a variety of operations associated with data processing. The operations can be based on tasks and on subtasks that are associated with the tasks. The 2D array can further interface with other elements such as controllers, storage elements, ALUs, memory management units (MMUs), GPUs, multiplier elements, and so on. The operations can accomplish a variety of processing objectives such as application processing, data manipulation, data analysis, and so on. The operations can manipulate a variety of data types including integer, real, floating-point, and character data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology.

The compute elements can further include a topology suited to machine learning computation. A topology for machine learning can include supervised learning, unsupervised learning, reinforcement learning, and other machine learning topologies. The compute elements can be coupled to other elements within the array of CEs. In embodiments, the coupling of the compute elements can enable one or more further topologies. The other elements to which the CEs can be coupled can include storage elements such as one or more levels of cache storage; control units; multiplier units; address generator units for generating load (LD) and store (ST) addresses; queues; register files; and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of elements such as cache elements, multiplier elements, ALU elements, or control elements; communication between or among neighboring CEs; and the like.

The flow 100 includes tagging 120 a load operation with a countdown tag. The countdown tag can include a value, a range, and so on that can be associated with load window during which a load operation can successfully deliver requested data to a compute element within the 2D array. In the flow 100, the tagging is performed 122 by the compiler. The compiler which generates the control words can include a general-purpose compiler such as a C, C++, or Python compiler; a hardware description language compiler such as a VHDL or Verilog compiler; a compiler written for the array of compute elements; and the like. In the flow 100, the load operation is targeted 124 to a memory system associated with the 2D array of compute elements. Discussed below and throughout, the memory system can include one or more blocks. In embodiments, the one or more blocks of the memory system can include a load buffer, a level 1 (L1) cache, a level 2 (L2) cache, a level 3 (L3) cache, an access buffer, a crossbar switch, or a memory logic block. More than one of any of the types of blocks can be included in the memory system.

In embodiments, the countdown tag can include a time value. The time value can be associated with an absolute time, a relative time, a “time to live”, and so on. The time value associated with the countdown tag can be decremented. In embodiments, the time value can be decremented as the load operation is being performed. The time value can be further decremented as the load data, load address, and tag travel through blocks associated with the memory system, elements associated with the 2D array of compute elements, etc., and onward to one or more target compute elements within the array of compute elements. The time value can be based on a variety of standard time units such as seconds (e.g., MKS units), abstract units such as cycles, and so on. In embodiments, the time value that is decremented can be based on an architectural cycle. The architectural cycle can be based on an architecture associated with the 2D array of compute elements, a configuration of the array, a static schedule assigned to the array, and the like. In embodiments, the architectural cycle can be established by the compiler. The architectural cycle established by the compiler can be based on one or more operations such as a read-modify-write operation. In embodiments, the architectural cycle can include one or more physical cycles. A physical cycle can be based on one or more of a setup time, a hold time, a reset time, etc. In embodiments, the physical cycles represent actual wall clock time. The flow 100 includes monitoring 130 countdown tag status by a control unit, wherein the monitoring occurs as the load operation is performed. The monitoring the countdown tag can include determining whether the countdown tag is nonzero, has reached zero, and so on. The monitoring can occur based on an architectural cycle, a physical cycle, and the like. The control unit that performs the monitoring can include a control element associated with the 2D array of compute elements, compute elements within the 2D array configured as a control unit, etc.

The flow 100 includes generating 140 a load status, by the control unit, based on the monitoring. The load status can be used to describe a state associated with the countdown tag. The load status can include states such as pending, tagged, valid, expires next cycle, expired, and so on. The load status can be used to set a priority for load operations, a precedence for the operations, and the like. In a usage example, a countdown tag associated with a load operation, where the tag is near to expiration or expires next cycle, can be given priority to complete the load operation prior to expiration. The load status can be used to control operation of the 2D array of compute elements. In embodiments, the load status allows compute element operation, based on a valid countdown tag. The compute element operation can include execution of one or more operations associated with one or more control words.

In embodiments, the load status can enable static scheduling integrity. A schedule such as a static schedule can be used to configure one or more compute elements within the 2D array of compute elements. The schedule can configure the 2D array to execute a graph, a directed graph, a directed acyclic graph (DAG), a Petri Net (PN), an artificial neural network (ANN), a machine learning (ML) network, etc. The graph or net can describe connections between tasks, subtasks, etc. The graph describes orders of operations, flows of data, and so on. The load status can enable static scheduling integrity by allowing compute element operation when the countdown tag is valid, halting operation when the countdown tag is invalid, and so on. The halting the compute element operation can continue until load data has arrived, then can allow compute element operation to resume. In embodiments, the static scheduling integrity can overcome indeterminate memory load latency. The indeterminate memory load latency can result for a memory system configuration which may not be known a priori by a compiler. The indeterminate memory load latency can further be based on a mix of tasks, subtasks, and so on scheduled on a 2D array of compute elements, sizes of datasets, data types, etc.

The control words can include wide control words, variable length control words, and so on. The control words can include microcode control words, compressed control words, encoded control words, and the like. The width of the control words enables a plurality of compute elements within the array of compute elements to be controlled by a single wide control word. For example, an entire row of compute elements can be controlled by that wide control word. The control words can be decompressed, used, etc., to configure the compute elements and other elements within the array; to enable or disable individual compute elements, rows and/or columns of compute elements; to load and store data; to route data to, from, and among compute elements; and so on. The control words that are generated by the compiler can include a conditionality such as a branch. The branch can include a conditional branch, an unconditional branch, etc. The control words can be a decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple, simultaneous programming loop instances circulating within the array of compute elements. The multiple programming loop instances can include multiple instances of the same programming loop, multiple programming loops, etc. Returning to the load status, in further embodiments, the load status can halt compute element operation, based on an expired countdown tag. The countdown tag can expire when the countdown reaches zero. The countdown tag can expire due to data requested by the load operation being unavailable. In embodiments, the expired countdown tag can indicate late load data arrival to the 2D array of compute elements.

Discussed previously, the load operation can include load data and a load address. The load data can include data obtained from local storage such as a register file or cache associate with a compute element, one or more levels of cache storage associated with the 2D array of compute elements, a memory system coupled to the 2D array, and so on. The load address can include a source address for the data, a target address associated with one or more compute elements, etc. In some embodiments, the countdown tag can flow through the 2D array of compute elements in conjunction with the load data and the load address. Alternatively, the countdown value can be assigned to the load address as it leaves the array of compute elements. Allowing the countdown tag to flow from the array in conjunction with the load address enables examination of the countdown tag as the load operation transits the 2D array, the memory system, and other components associated with the 2D array. In embodiments, the countdown tag can be examined in one or more blocks of the memory system. The transit of the load operation through a given memory system block can require one or more physical cycles. Examining the countdown tag enables close monitoring of the countdown tag by the memory system blocks. In embodiments, the one or more blocks of the memory system can include a load buffer, a level 1 (L1) cache, a level 2 (L2) cache, a level 3 (L3) cache, an access buffer, a crossbar switch, or a memory logic block.

The flow 100 further includes signaling 150 the control unit of a countdown tag expiration, by at least one of the one or more blocks of the memory system. The signaling can include setting a flag or semaphore, firing an interrupt or exception, sending a message, and so on. Since any one of the memory system blocks can potentially signal the control unit, the control unit can respond faster than if signaling the countdown tag expiration were only accomplished by the controller. The flow 100 further includes halting 160 the array of compute elements, based on the load status. The halting the array of compute elements can be based on an expiration of a single countdown tag, expiration of a plurality of tags, and the like. In embodiments, the load status for halting the array can include a late load data status. The late load data status can result from expiration of the countdown tag as described, unavailability of data required for the load operation, etc. In embodiments, the halting the array of compute elements can be initiated by the control unit. The control unit can halt compute element operation, save one or more states associated with one or more compute elements, preserve or flush buffers such as access buffers or data buffers, and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

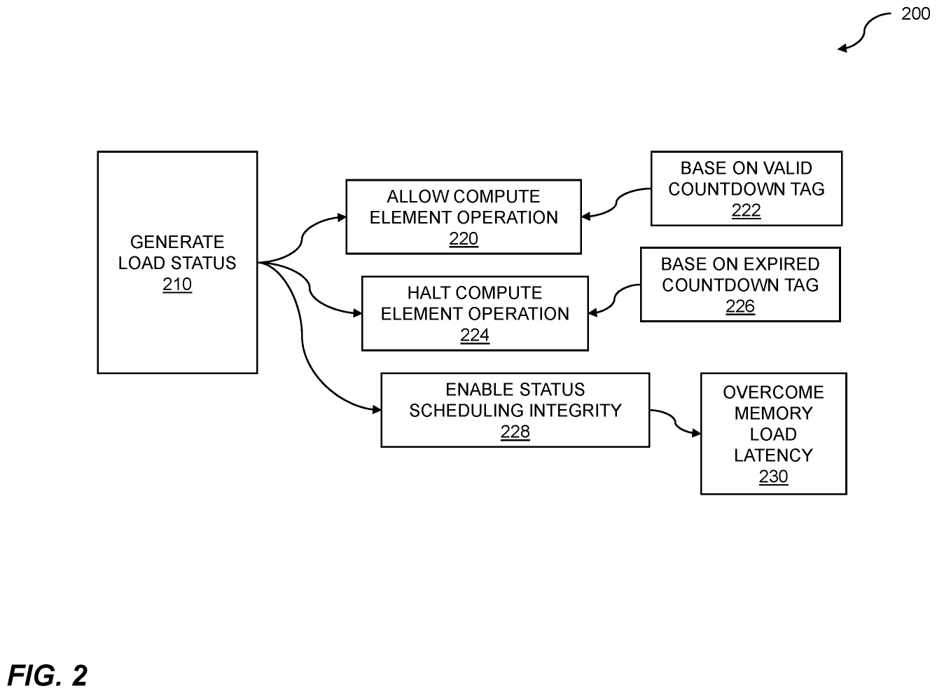

FIG. 2 is a flow diagram for load status handling. Collections or clusters of compute elements (CEs), such as CEs assembled within a 2D array of CEs, can be configured to execute a variety of operations associated with programs. The operations can be based on tasks, and subtasks that are associated with the tasks. The 2D array can further interface with other elements such as controllers, storage elements, ALUs, MMUs, GPUs, multiplier elements, and the like. The operations can accomplish a variety of processing objectives such as application processing, data manipulation, design and simulation, and so on. The operations can perform manipulations of a variety of data types including integer, real, floating-point, and character data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence compute element results.

The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by a control word to implement one or more of a systolic, a vector, a cyclic, a spatial, a streaming, or a Very Long Instruction Word (VLIW) topology.

The compute elements can further include one or more topologies, where a topology can be mapped by the compiler. The topology mapped by the compiler can include a graph such as a directed graph (DG) or directed acyclic graph (DAG), a Petri Net (PN), etc. In embodiments, the compiler maps machine learning functionality to the array of compute elements. The machine learning can be based on supervised, unsupervised, and semi-supervised learning; deep learning (DL); and the like. In embodiments, the machine learning functionality can include a neural network implementation. The compute elements can be coupled to other elements within the array of CEs. In embodiments, the coupling of the compute elements can enable one or more topologies. The other elements to which the CEs can be coupled can include storage elements such as one or more levels of cache storage, multiplier units, address generator units for generating load (LD) and store (ST) addresses, queues, and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like.

The control enables execution of a compiled program on the array of compute elements. The compute elements can access registers that contain control words, data, and so on. The compute elements can further access a memory system. The memory system enables loading of data, storing of data, and so on. In order for tasks and subtasks to be executed on the array of compute elements, data required by the tasks and subtasks must be available to the compute elements for processing at the time operations associated with the tasks and subtasks are scheduled to initiate execution. Since access the memory system can require one or more cycles such as architectural cycles to accomplish a load operation, and since access by a compute element to the memory system can be temporarily delayed due to memory system contention, a countdown tag can be associated with the load operation. The countdown tag can indicate a time value that can indicate a maximum duration of time, number of cycles, etc., during which the load data must be received by the one or more compute elements that initiated the load operation. If the data arrives in time, then compute element operation can proceed. If the data is late, then compute element operation is halted. The tagging of a load operation with a countdown tag enables a parallel processing architecture. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit, based on the monitoring.

The flow 200 includes generating 210 a load status. The load status can be generated by the control unit, based on monitoring of countdown tag status. The load status can include a value, text, a signal, a flag, a semaphore, and so on. The load status can be based on a state associated with the countdown tag. The load status can include tagged, valid, pending, expired, and so on. The load status can be used to set a priority for load operations, a precedence for the operations, and the like. In a usage example, load operations comprising load data, load addresses, and associated tags can be initiated by operations associated with compute elements within the 2D array. The load operations can be sorted such that one or more load operations with smaller countdown tags can be prioritized over one or more load operations with larger countdown tags. Discussed above and throughout, the load status that is generated by the control unit can be used to control compute element operation.

In the flow 200, the load status allows 220 compute element operation. The allowing operation of the array can include enabling one or more compute elements to execute one or more operations. The operations can include arithmetic operations; logic operations; array, matrix, or tensor operations; etc. The allowing operation can be applied to a compute element, a row or column of compute elements, a cluster or region of compute elements, and so on. The allowing operation can include allowing the compute elements to operate autonomously. In the flow 200, the allowing compute element operation is based on a valid countdown tag 222. The valid countdown tag can include an unexpired tag, a nonzero tag, etc. In the flow 200, the load status halts 224 compute element operation. The halting operation can include suspending operation. The halting operation can cause the storage of one or more compute element states, storing or flushing of queues, and the like. In the flow 200, the halting of the compute element operation is based on an expired countdown tag 226. The countdown tag can be determined to be expired based on an elapsed time value, a number of cycles, and so on. The countdown tag can be determined to be expired based on an unavailability of data to be processed.

The enabling compute element operation and halting compute element operation can in part accomplish control of elements within the 2D array of compute elements. The array of compute elements can be controlled on a cycle-by-cycle basis. The control for the array can include configuring elements such as compute elements and storage elements within the array; loading and storing data; routing data to, from, and among compute elements; and so on. The control is enabled by a stream of wide control words generated by the compiler. The control words can configure the compute elements and other elements within the array; enable or disable individual compute elements or rows and/or columns of compute elements; load and store data; route data to, from, and among compute elements; etc. The one or more control words are generated by the compiler as discussed above. The compiler can be used to map functionality to the array of compute elements. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is a control word portion, which can be called a control word bunch, required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

Recall that a load status can be generated by the control unit. The load status is generated based on monitoring countdown tag status. The countdown tag status is monitored by the control unit, and the monitoring occurs as the load operation is performed. In the flow 200, the load status enables static scheduling integrity 228. A static schedule can be used to configure compute elements within the 2D array of compute elements. Discussed previously, the schedule can configure the 2D array to execute a graph, a directed graph, a directed acyclic graph (DAG), a Petri Net (PN), etc. The graph or net can describe connections between tasks, subtasks, etc. The graph describes orders of operations, flows of data, and so on. The load status enables static scheduling integrity by allowing compute element operation when the countdown tag is valid, and halting operation when the countdown tag is invalid. The halting the compute element operation can continue until load data has arrived, then can allow compute element operation to resume. In the flow 200, the static scheduling integrity overcomes 230 indeterminate memory load latency. The indeterminate memory load latency can result for a memory system configuration which may not be known a priori by a compiler. The indeterminate memory load latency can further be based on a mix of tasks, subtasks, and so on scheduled on a 2D array of compute elements, sizes of datasets, data types, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

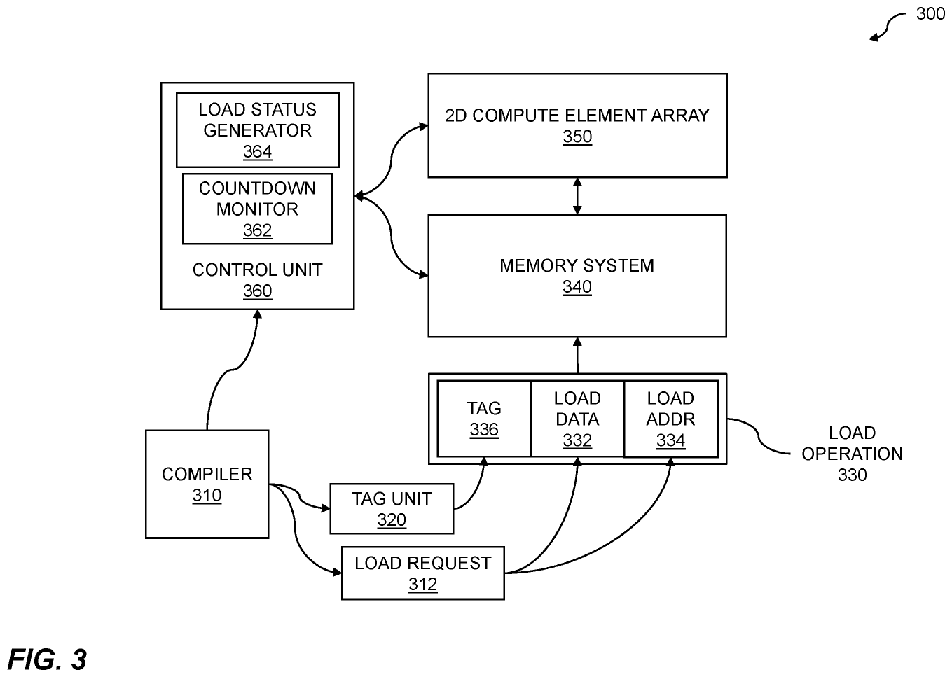

FIG. 3 is a high-level system block diagram for load tagging. Load tagging is a technique that can be used to tag a load operation. The tag can include a countdown tag, where countdown associated with the tag can be based on a number of cycles, an amount of time, and so on. The countdown tag can include an amount of time that can elapse, a time that the data obtained by the load operation is required by a compute element, and so on. A status associated with the countdown can be monitored, and the status can be used to allow compute element operation based on a valid countdown status, or to halt compute element operation based on an expired countdown status. The expired countdown tag status indicates late load data arrival to the 2D array of compute elements. The load tagging, the countdown tag monitoring, and so on are enabled by a parallel processing architecture with countdown tagging. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit based on the monitoring.

The figure shows a system block diagram for load tagging. A tag can include an absolute value, a relative value, and so on. The tag can include a countdown tag, can be associated with a load operation, and can flow through an array of compute elements along with load data and a load address. The countdown tag can be examined by one or more blocks of a memory system. If the countdown tag is valid, then the tag and the associated load operation can continue to flow through the array of compute elements. If the countdown tag has expired, then a control unit associated with the 2D array of compute elements can be signaled that the countdown tag has expired. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit, based on the monitoring.

The system block diagram 300 can include a compiler 310. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can include a specialized compiler for the 2D array of compute elements. The compiler can generate a set of directions that can be provided to the compute elements and other elements within the array. The compiler can be used to compile processes, tasks, subtasks, and so on. The processes, tasks, subtasks, etc. can comprise one or more operations. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for performing operations such as arithmetic, vector, array, and matrix operations; Boolean operations; and so on. The operations can generate results. In embodiments, the compute element results are generated in parallel in the array of compute elements. Parallel results can be generated by compute elements when the compute elements can share input data, use independent data, and the like.

The compiler can generate a set of directions that controls data movement for the array of compute elements. The control of data movement can include movement of data to, from, and among compute elements within the array of compute elements. The control of data movement can include loading and storing data, such as temporary data storage, during data movement. The data movement can include intra-array data movement. In the block diagram 300, the load request 312 is generated by the compiler. The load request can include a request to load a variety of types of data, where the data can include integer, real, float, character, array, matrix, tensor, and other types of data. The block diagram can include a tag unit 320. The tag unit can generate a tag specified by the compiler. The tag can include a countdown tag, where the countdown tag can include a number of cycles required to load data, a “time to live” value, and so on. In embodiments, the countdown tag can include a time value. The time value can include an allowable amount of elapsed time, a number of cycles, and the like. In embodiments, the time value can be based on an architectural cycle. An architectural cycle can be based on one or more operations executed by the 2D array of compute elements, such as a load operation, a processing operation, a store operation, etc. In embodiments, the architectural cycle can be established by the compiler 310. An architectural cycle can be based on one or more other cycles such as physical cycles. In embodiments, the physical cycles represent actual wall clock time.

The system block diagram can include a load operation 330. The load operation can be used to obtain data from storage, where the storage can include a register file, storage adjacent to the compute elements within the 2D array, cache storage, a memory system, and so on. In embodiments, the load operation can include load data 332 and a load address 334. The load data and the load address can be provided by the load request 312 generated by the compiler 310. In addition to the load data and the load address, a tag 336, such as a countdown tag, can be provided by the tag unit. In the block diagram, the load operation can be provided to a memory system 340 or other storage elements in order to obtain data. The memory system can comprise one or more components, blocks, and so on. In embodiments, the one or more blocks of the memory system can include a load buffer, a level 1 (L1) cache, a level 2 (L2) cache, a level 3 (L3) cache, an access buffer, a crossbar switch, or a memory logic block. More than one of a given block type can be included in the memory system. In embodiments, the countdown tag can be examined in one or more blocks of the memory system. The examining can include determining whether the countdown tag is valid, is near to expiration, has expired, and so on.

In the system block diagram, the data associated with the load operation can be provided for processing by the 2D compute element array 350. Discussed previously and throughout, the 2D array of compute elements can include multiplier elements, arithmetic logic unit (ALU) elements, etc. In some embodiments, the countdown tag can flow through the 2D array of compute elements in conjunction with the load data and the load address. Alternatively, the countdown value can be assigned to the load address as it leaves the array of compute elements. Allowing the countdown tag to flow from the array in conjunction with the load address enables examination of the countdown tag as the load operation transits the 2D array, the memory system, and other components associated with the 2D array. Discussed previously, the countdown tag can be examined by one or more blocks of the memory system. The examining by a memory system block enables determination of whether the countdown tag is valid or has expired. Embodiments further include signaling a control unit of a countdown tag expiration by at least one of the one or more blocks of the memory system. The system block diagram can include a control unit 360. The control unit can configure one or more compute elements within the 2D array of compute elements, enable operation of compute elements, halt or suspend operation of compute elements, and so on. The control unit can include a countdown monitor 362. The countdown monitor can monitor a countdown tag status. In embodiments, the monitoring can occur as the load operation is performed. The monitoring can include monitoring progress of the load operation as the load operation flows through the 2D array. The control unit can further include a load status generator 364. In embodiments, a load status can be generated by the control unit based on the monitoring. The monitoring the load status can be used to control operation of the 2D array of compute elements. In embodiments, the load status can allow compute element operation, based on a valid countdown tag. If the countdown tag is valid, then the data associated with the tag can be considered valid, and processing of the data can proceed. In other embodiments, the load status can halt compute element operation, based on an expired countdown tag. If the countdown tag has expired, then the data associated with the countdown tag can be considered invalid or missing for processing. In embodiments, the expired countdown tag can indicate late load data arrival to the 2D array of compute elements. The late load data arrival can further cause storage of the state of the 2D array, caches, or buffers to be flushed, etc.

The highly parallel architecture can comprise components including compute elements, processing elements, buffers, one or more levels of cache storage, system management, control units, arithmetic logic units, multipliers, memory management units, and so on. The various components can be used to accomplish parallel processing of processes, tasks, subtasks, and so on. The task processing is associated with program execution, job processing, etc. The task processing is enabled based on a parallel processing architecture with countdown tagging. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit based on the monitoring. The load status allows compute element operation, based on a valid countdown tag. The load status halts compute element operation, based on an expired countdown tag.

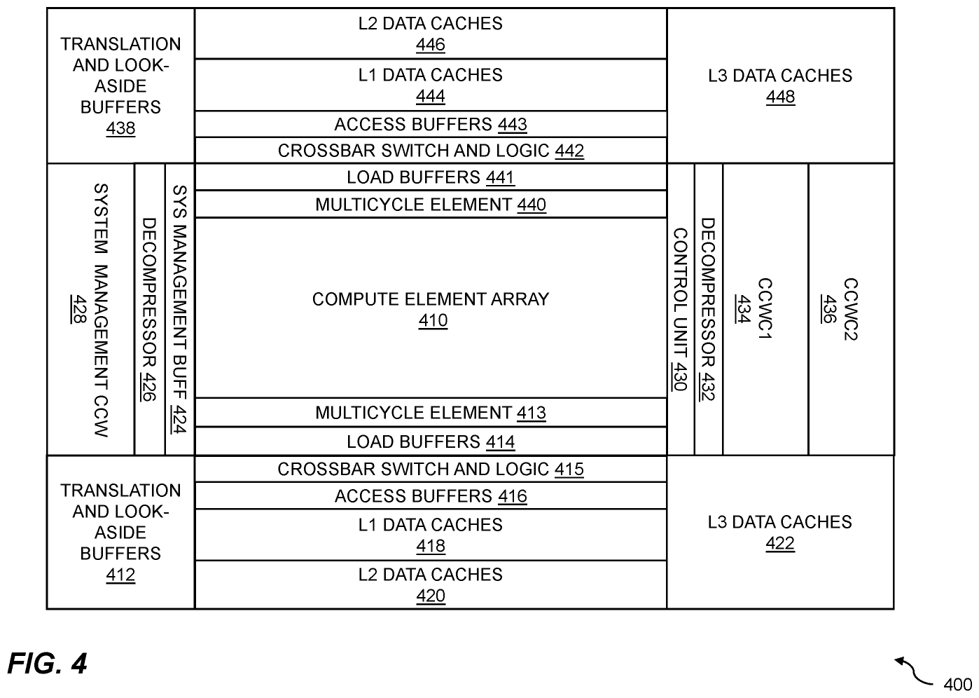

FIG. 4 illustrates a system block diagram for a highly parallel architecture with a shallow pipeline. The highly parallel architecture can comprise components including compute elements, processing elements, buffers, one or more levels of cache storage, system management, arithmetic logic units, multicycle elements for computing multiplication, division, and square root operations, and so on. The various components can be used to accomplish parallel processing of tasks, subtasks, and the like. The parallel processing is associated with program execution, job processing, etc. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit based on the monitoring.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times.

The system block diagram 400 can include logic for load and store access order and selection. The logic for load and store access order and selection can include crossbar switch and logic 415 along with crossbar switch and logic 442. Crossbar switch and logic 415 can accomplish load and store access order and selection for the lower data cache blocks (418 and 420), and crossbar switch and logic 442 can accomplish load and store access order and selection for the upper data cache blocks (444 and 446). Crossbar switch and logic 415 enables high-speed data communication between the lower-half compute elements of compute element array 410 and data caches 418 and 420 using access buffers 416. Crossbar switch and logic 442 enables high-speed data communication between the upper-half compute elements of compute element array 410 and data caches 444 and 446 using access buffers 443. The access buffers 416 and 443 allow logic 415 and logic 442, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 418 and 420 and upper data caches 444 and 446.

The system block diagram 400 can include lower load buffers 414 and upper load buffers 441. The load buffers can provide temporary storage for memory load data so that it is ready for low latency access by the compute element array 410. The system block diagram can include dual level 1 (L1) data caches, such as L1 data caches 418 and 444. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include lower multicycle element 413 and upper multicycle element 440. The multicycle elements (MEMs) can provide efficient functionality for operations that span multiple cycles, such as multiplication operations. The MEMs can provide further functionality for operations that can be of indeterminant cycle length, such as some division operations, square root operations, and the like. The MEMs can operate on data coming out of the compute element array and/or data moving into the compute element array. Multicycle element 413 can be coupled to the compute element array 410 and load buffers 414, and multicycle element 440 can be coupled to compute element array 410 and load buffers 441.

The system block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the uncompressed control words. The system management CCW component 428 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432 and can drive out the decompressed control word into the appropriate compute elements of compute element array 410. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

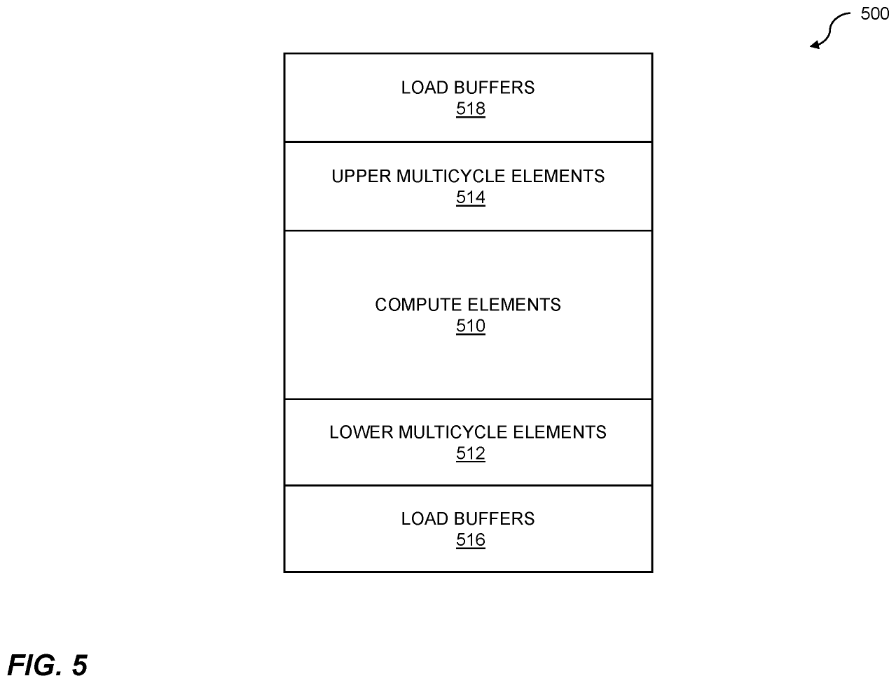

FIG. 5 shows compute element array detail 500. A compute element array can be coupled to components which enable compute elements within the array to process one or more tasks, subtasks, and so on. The tasks, subtasks, etc. can be processed in parallel. The components can access and provide data, perform specific high-speed operations, and the like. The compute element array and its associated components enable parallel processing hazard mitigation avoidance. The compute element array 510 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 512 and upper multicycle elements 514. The multicycle elements can provide functionality to perform, for example, high-speed multiplications associated with general processing tasks, multiplications associated with neural networks such as deep learning networks, multiplications associated with vector operations, and the like. The multiplication operations can span multiple cycles. The MEMs can provide further functionality for operations that can be of indeterminant cycle length, such as some division operations, square root operations, and the like.

The compute elements can be coupled to load buffers such as load buffers 516 and load buffers 518. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories can be beneficial while the array is paused. This mechanism can operate such that the array state is known, as far as the compiler is concerned. When array operation resumes after a pause, new load data will have arrived at a scratchpad, as required for the compiler to maintain the statically scheduled model.

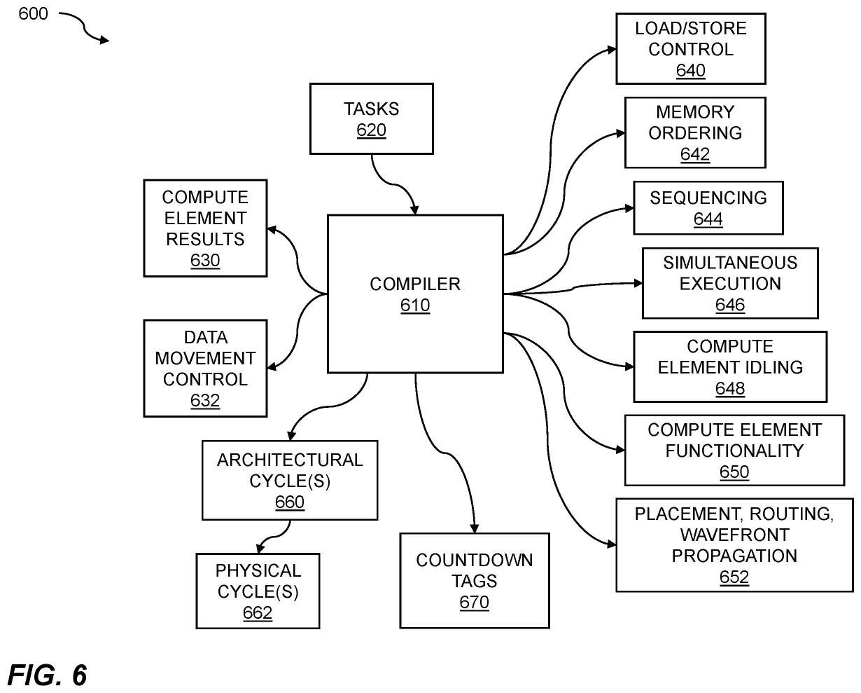

FIG. 6 illustrates a system block diagram for compiler interactions. Discussed throughout, compute elements within a 2D array are known to a compiler which can compile tasks and subtasks for execution on the array. The compiled tasks and subtasks are executed to accomplish parallel processing. A variety of interactions, such as placement of tasks and subtasks, routing of data, and so on, can be associated with the compiler. The compiler interactions enable a parallel processing architecture with countdown tagging. A two-dimensional (2D) array of compute elements is accessed, wherein each compute element within the array of compute elements is known to a compiler and is coupled to its neighboring compute elements within the array of compute elements. A load operation is tagged with a countdown tag, wherein the tagging is performed by the compiler, and wherein the load operation is targeted to a memory system associated with the 2D array of compute elements. Countdown tag status is monitored by a control unit, wherein the monitoring occurs as the load operation is performed. A load status is generated by the control unit based on the monitoring.

The system block diagram 600 includes a compiler 610. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as a low-level virtual machine (LLVM) intermediate representation (IR). The compiler can generate a set of directions that can be provided to the compute elements and other elements within the array. The compiler can be used to compile tasks 620. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtask handling, input data handling, intermediate and resultant data handling, and so on. The compiler can further generate directions for configuring the compute elements, storage elements, control units, ALUs, and so on associated with the array. As previously discussed, the compiler generates directions for data handling to support the task handling. In the system block diagram, the data movement can include loads and stores 640 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, a level 2 (L2) cache, a level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, and so on. The memory data ordering can enable parallel execution of tasks and subtasks.

In the system block diagram 600, the ordering of memory data can enable compute element result sequencing 644. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 646 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, then the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 648. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 650. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 652 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met, That is, the array of compute elements does not have to wait for either dependent data to load or for a full memory queue to clear. In the system block diagram, the architectural cycle can include one or more physical cycles 662. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and double-words.

In the system block diagram, the compiler can control countdown tags 670. Discussed previously and throughout, the compiler 610 can perform the tagging. The tag can be used to indicate a number of cycles, such as architectural cycles, that can tick past before data accessed by the load operation is required for processing by a compute element within the 2D array of compute elements. In embodiments, the countdown tag comprises a time value. The time value can be based on a number of cycles, a specific cycle such as current cycle plus N cycles, and so on. The time value can include a “time to live” and so on. In embodiments, the time value can be decremented as the load operation is being performed. The decrement can be based on a “time unit” or cycle such as an architectural cycle. The architectural cycle can be established using a variety of techniques. In embodiments, the architectural cycle can be established by the compiler. The architectural cycle can be based on one or more operations that can be performed by the 2D array of compute elements. In a usage example, the architectural cycle can be based on read-modify-write operations. Each operation can require one or more physical cycles to be operated upon by one or more compute elements. In embodiments, the architectural cycle can include one or more physical cycles, where a physical cycle can represent real or “wall clock” time.

The load operation is used to retrieve, from one or more storage elements, data required by a processing task assigned to a compute element within the array of compute elements. In embodiments, the load operation can include load data and a load address. The load address can include an address within storage local to the 2D array of compute elements, cache storage, one or more memory systems available to a system of which the 2D array is component, and so on. In some embodiments, the countdown tag can flow through the 2D array of compute elements in conjunction with the load data and the load address. Alternatively, the countdown value can be assigned to the load address as it leaves the array of compute elements. Allowing the countdown tag to flow from the array in conjunction with the load address enables examination of the countdown tag as the load operation transits the 2D array, the memory system, and other components associated with the 2D array. In other embodiments, the countdown tag can be examined in one or more blocks of the memory system. The examining the countdown tag can enable the countdown tag to be used to set a load priority, a load preference, etc. In embodiments, countdown tag status can be monitored by a control unit, wherein the monitoring occurs as the load operation is performed. The monitoring the status can be used to determine whether the load operation can occur with a time window required by the compiler, etc. The control unit can use the countdown tag status to enable or allow compute element operation, where the allowed operation can be based on a valid countdown tag. Conversely, the control unit can use the load status to halt compute element operation based on an expired countdown tag. In embodiments, the expired countdown tag can indicate late load data arrival to the 2D array of compute elements.

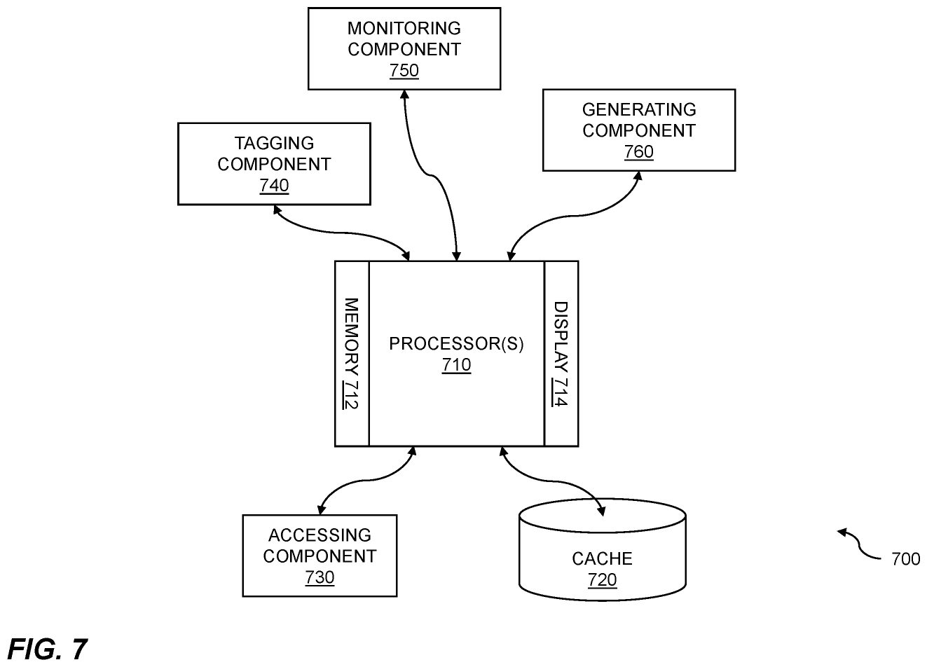

FIG. 7 is a system diagram for a parallel processing. The parallel processing is enabled by a parallel processing architecture with countdown tagging. The system 700 can include one or more processors 710, which are attached to a memory 712 which stores instructions. The system 700 can further include a display 714 coupled to the one or more processors 710 for displaying data; countdown tags, intermediate steps; directions; control words; compressed control words; control words implementing Very Long Instruction Word (VLIW) functionality; topologies including systolic, vector, cyclic, spatial, streaming, or VLIW topologies; and so on. In embodiments, one or more processors 710 are coupled to the memory 712, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; tag a load operation with a countdown tag, wherein the tagging is performed by the compiler, and wherein the load operation is targeted to a memory system associated with the 2D array of compute elements; monitor countdown tag status by a control unit, wherein the monitoring occurs as the load operation is performed; and generate a load status, by the control unit, based on the monitoring. The compute elements can include compute elements within one or more integrated circuits or chips, compute elements or cores configured within one or more programmable chips such as application specific integrated circuits (ASICs), field programmable gate arrays (FPGAs), heterogeneous processors configured as a mesh, standalone processors, etc.

The system 700 can include a cache 720. The cache 720 can be used to store data such as data associated with processes, tasks, subtasks, routines, subroutines, functions, and so on. The cache can include mapping data for mapping virtual register files to physical register files. The mapping can be based on 2R1 W register files which can include mapping of the virtual registers and renaming by the compiler. The cache can further include directions to compute elements, control words, compressed control words, load operation tags, intermediate results, microcode, branch decisions, and so on. The cache can comprise a small, local, easily accessible memory available to one or more compute elements. Embodiments include storing relevant portions of a control word within the cache associated with the array of compute elements. The cache can be accessible to one or more compute elements. The cache, if present, can include a dual read, single write (2R1 W) cache. That is, the 2R1 W cache can enable two read operations and one write operation contemporaneously without the read and write operations interfering with one another. The cache can comprise one or more levels of cache such as a level 1 (L1) cache, a level 2 (L2) cache, a level 3 (L3) cache, etc. The levels of cache can increase in size between L2 and L2, L2 and L3, and so on.

The system 700 can include an accessing component 730. The accessing component 730 can include control logic and functions for accessing a two-dimensional (2D) array of compute elements. Each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX).

The system 700 can include a tagging component 740. The tagging component 740 can include control and functions for tagging a load operation with a countdown tag. The tag can be based on a number of cycles, a relative number of cycles, and so on. In embodiments, the countdown tag can include a time value. The time value can be based on elapsed time, “time to live”, and the like. The time value can include a maximum amount of allowable elapsed time for data to reach a target compute element. In embodiments, time value is decremented as the load operation is being performed. The load can obtain data from a register file, storage local to one or more compute elements, cache storage, etc. The tagging is performed by the compiler, and the load operation is targeted to a memory system associated with the 2D array of compute elements. In embodiments, the time value that is decremented can be based on an architectural cycle. An architectural cycle can be based on one or more operations such as a memory or storage access operation, a read-modify-write operation for processing data, and the like. In embodiments, the architectural cycle can be established by the compiler. The architectural cycle can further be based on a configuration of the 2D array, a topology associated with the 2D array, etc.

The system block diagram 700 can include a monitoring component 750. The monitoring component 750 can include control and functions for monitoring countdown tag status by a control unit. The status can include tagged, valid, pending, expired, and so on. The monitoring occurs as the load operation is performed. The load operation can include accessing addresses associated with a memory system, transferring the data through the 2D array, providing the data to the target compute element, and so on. The executing the load operation can include one or more architectural cycles, physical cycles, and so on. The countdown value can be assigned to the load address as it leaves the array of compute elements. Allowing the countdown tag to flow from the array in conjunction with the load address enables examination of the countdown tag as the load operation transits the 2D array, the memory system, and other components associated with the 2D array. The control unit can further be used to control the array of compute elements on a cycle-by-cycle basis. The controlling can be enabled by a stream of wide control words generated by the compiler. The control words can be based on low-level control words such as assembly language words, microcode words, firmware words, and so on. The control words can be of variable length, such that a different number of operations for a differing plurality of compute elements can be conveyed in each control word. The control of the array of compute elements on a cycle-by-cycle basis can include configuring the array to perform various compute operations. In embodiments, the stream of wide control words comprises variable length control words generated by the compiler. In embodiments, the stream of wide, variable length control words generated by the compiler provides direct fine-grained control of the 2D array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

The system block diagram 700 includes a generating component 760. The generating component 760 can include control and functions for generating a load status, by the control unit, based on the monitoring. The generated load status can indicate whether the tag is valid, expired, and so on. The generated load status can be used to control the 2D array of compute elements. In embodiments, the load status can allow compute element operation, based on a valid countdown tag. The allowing compute element operation can include obtaining data, processing data, sending data to one or more further compute elements, storing data, etc. In other embodiments, the load status can halt compute element operation, based on an expired countdown tag. The expired countdown tag can be based on an exception, an error condition, and the like. In embodiments, the expired countdown tag can indicate late load data arrival to the 2D array of compute elements. The late load data arrival can be based on delayed or incomplete execution of an upstream process, tasks, subtasks, and so on. The late load data arrival can be based on memory system conflicts, bus contention, load register error (e.g., the load register contains the wrong data), etc. In embodiments, the load status can enable static scheduling integrity. Since one or more control words can be associated with a load operation, “late data” can result in one or more control words for configuring the 2D array not arriving in time, which would result in an invalid 2D array configuration. In embodiments, the static scheduling integrity can overcome indeterminate memory load latency.

The tag associated with a load operation can be examined by, modified by, and so on, blocks of the memory system. The modifying can include decrementing the tag. In embodiments, the countdown tag can be examined in one or more blocks of the memory system. The one or more blocks of memory system can determine that the tag is valid or expired. In embodiments, the one or more blocks of the memory system can include a load buffer, a level 1 (L1) cache, a level 2 (L2) cache, a level 3 (L3) cache, an access buffer, a crossbar switch, or a memory logic block. If any one of the blocks of the memory system determines that a tag has expired, then a variety of actions can be taken. Further embodiments include signaling the control unit of a countdown tag expiration by at least one of the one or more blocks of the memory system. The signal can include a flag, a semaphore, a message, and the like. Further embodiments include halting the array of compute elements, based on the load status. The halting can cause the array status to be stored, buffers to be flushed, and the like. In embodiments, the load status for halting the array can include a late load data status. The status can further include partial data, invalid data, etc. In embodiments, the halting the array of compute elements can be initiated by the control unit. More than one control unit can be associated with the 2D array of compute elements.

The system 700 can include a computer program product embodied in a non-transitory computer readable medium for parallel processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; tagging a load operation with a countdown tag, wherein the tagging is performed by the compiler, and wherein the load operation is targeted to a memory system associated with the 2D array of compute elements; monitoring countdown tag status by a control unit, wherein the monitoring occurs as the load operation is performed; and generating a load status, by the control unit, based on the monitoring.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing a two-dimensional (2D) array of compute elements, wherein each compute element within the array of compute elements is known to a compiler and is coupled to its neighboring compute elements within the array of compute elements;
tagging a load operation with a countdown tag, wherein the tagging is performed by the compiler, and wherein the load operation is targeted to a memory system associated with the 2D array of compute elements;
monitoring countdown tag status by a control unit, wherein the monitoring occurs as the load operation is performed; and
generating a load status, by the control unit, based on the monitoring.

2. The method of claim 1 wherein the countdown tag comprises a time value.

3. The method of claim 2 wherein the time value is decremented as the load operation is being performed.

4. The method of claim 3 wherein the time value that is decremented is based on an architectural cycle.

5. The method of claim 4 wherein the architectural cycle is established by the compiler.

6. The method of claim 4 wherein the architectural cycle comprises one or more physical cycles.

7. The method of claim 6 wherein the physical cycles represent actual wall clock time.

8. The method of claim 1 wherein the load status allows compute element operation, based on a valid countdown tag.

9. The method of claim 1 wherein the load status halts compute element operation, based on an expired countdown tag.

10. The method of claim 9 wherein the expired countdown tag indicates late load data arrival to the 2D array of compute elements.

11. The method of claim 1 wherein the load operation comprises load data and a load address.

12. The method of claim 11 wherein the countdown tag flows through the 2D array of compute elements in conjunction with the load data and the load address.

13. The method of claim 12 wherein the countdown tag is examined in one or more blocks of the memory system.

14. The method of claim 13 further comprising signaling the control unit of a countdown tag expiration by at least one of the one or more blocks of the memory system.

15. The method of claim 13 wherein the one or more blocks of the memory system comprise a load buffer, a level 1 (L1) cache, a level 2 (L2) cache, a level 3 (L3) cache, an access buffer, a crossbar switch, or a memory logic block.

16. The method of claim 1 further comprising halting the array of compute elements, based on the load status.

17. The method of claim 16 wherein the load status for halting the array includes a late load data status.

18. The method of claim 16 wherein the halting the array of compute elements is initiated by the control unit.

19. The method of claim 1 wherein the load status enables static scheduling integrity.

20. The method of claim 19 wherein the static scheduling integrity overcomes indeterminate memory load latency.

21. A computer program product embodied in a non-transitory computer readable medium for parallel processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
tagging a load operation with a countdown tag, wherein the tagging is performed by the compiler, and wherein the load operation is targeted to a memory system associated with the 2D array of compute elements;
monitoring countdown tag status by a control unit, wherein the monitoring occurs as the load operation is performed; and
generating a load status, by the control unit, based on the monitoring.

22. A computer system for parallel processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
tag a load operation with a countdown tag, wherein the tagging is performed by the compiler, and wherein the load operation is targeted to a memory system associated with the 2D array of compute elements;
monitor countdown tag status by a control unit, wherein the monitoring occurs as the load operation is performed; and
generate a load status, by the control unit, based on the monitoring.
